(19) United States
(12) Patent Application Publication
(10) Pub. No.: US 2004/0083290 A1
(43) Pub. Date: Apr. 29, 2004

(54) Software implemented virtual private network service

(76) Inventors: Zesen Chen, Pleasanton, CA (US); Brian Gonsalves, Pleasanton, CA (US)

Correspondence Address: BRINKS HOFER GILSON & LIONE, POST OFFICE BOX 10395, CHICAGO, IL, 60610, US

(21) Appl. No.: 10/281,056

(22) Filed: Oct. 25, 2002

(51) Int. Cl. G06F 15/16

(52) U.S. Cl. 709/227; 709/245

(57) ABSTRACT

A method and system for implementing a virtual private network utilizes a single public IP address and avoids the use of a firewall. The method includes having a router in a private network perform one-to-one mapping of a public IP address to a private IP address such that a firewall, and the additional public IP address typically used to access the firewall, are not used. The system comprises a router having instructions for one-to-one mapping of a public IP address to a private IP address and does not include a firewall.

### FIELD OF THE INVENTION

The present invention relates to an apparatus and method for permitting communication between remotely located computers over a virtual private network. More particularly, the present invention relates to a method and apparatus for virtual private network communications that helps minimize use of network resources.

### BACKGROUND

A virtual private network (VPN) is a form of network that provides connectivity between various computers and provides the characteristics of a private network over shared network infrastructure. By sharing existing infrastructure, different entities that subscribe to virtual private networks avoid the costs of maintaining dedicated private lines and service providers are able to achieve better usage of their existing network infrastructure.

A traditional solution/design for one type of virtual private network topology is illustrated in FIG. 1. In this example, a VPN network for site-to-site remote connection and site-to-remote client connection is displayed. VPN clients 10 communicate over communication lines 12 with a corporate local area network (LAN) 14, or other private network, via the Internet 16. Traditionally, the VPN site for the private network 14 comprises a modem 18, in communication with a firewall 20, using a connection with at least two public Internet protocol (IP) addresses. The first Internet protocol address is the address of the modem to which the remotely located VPN clients 10 would direct queries and the second Internet protocol address is typically the separate address for the firewall. Firewalls function as a security net for private networks by creating a single entry point for network traffic that allows the private network to weed out undesirable attacks on the network and also to translate the public IP address to an appropriate internal network or private IP address.

Although the configuration of a firewall and multiple IP addresses is functional, there is a need for a simpler method of communicating between VPN clients and private networks that reduces costs and complexity.

### BRIEF SUMMARY

In order to address the deficiencies in the prior art and provide improved performance, an improved apparatus and method are provided for communicating between remotely located computers over a virtual private network. According to a first aspect of the invention, a method is provided where a query is received from a remotely located computer on a communication line over the Internet. The queries are received at a router associated with a public Internet protocol address. The router maps the public Internet protocol address to a private internal network address without the use of a firewall. A virtual private network connection over the communication line is then established such that communication between a host computer associated with the private internal network address and the remotely located computer that queried the router may proceed, wherein the host computer is accessible via the single public Internet protocol address of the router without the need of additional public Internet protocol addresses or a firewall. In one embodiment, the communication line is a digital subscriber line and the router is a digital subscriber line router.

According to another aspect of the invention, a system for implementing a virtual private network over an Internet connection is disclosed. The system includes a router having at least one public Internet protocol address, where the router contains software instructions for mapping each of the public Internet protocol addresses to a respective unique private Internet protocol address. The system also includes a virtual private network host associated with the private Internet protocol address. The virtual private network host establishes a virtual public network connection with the remotely located computer via the public Internet protocol address and the public Internet protocol address via the one-to-one mapping feature of the router without an intervening firewall and without the need for a second public IP address associated with a firewall.

### BRIEF DESCRIPTION OF THE DRAWINGS

FIG. 1 is a block diagram of a traditional VPN network.

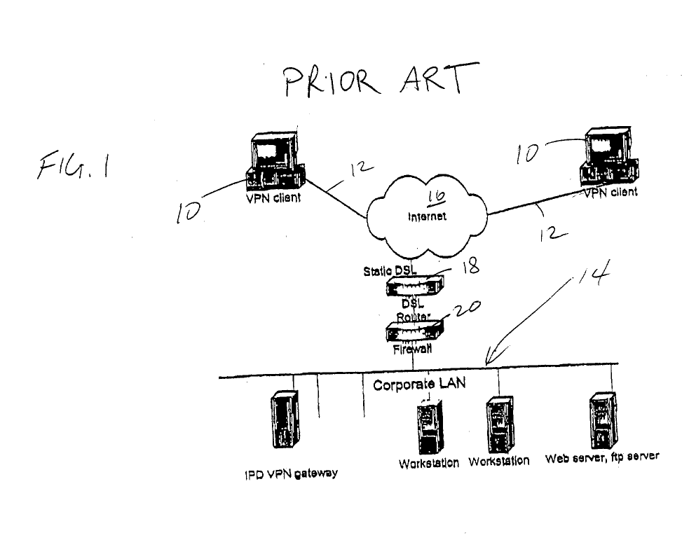

FIG. 2 is a block diagram of a VPN network according to one embodiment of the present invention.

FIG. 3 is a flow chart illustrating a method of establishing a VPN connection over the VPN network of FIG. 2.

### DETAILED DESCRIPTION OF THE PRESENTLY PREFERRED EMBODIMENTS

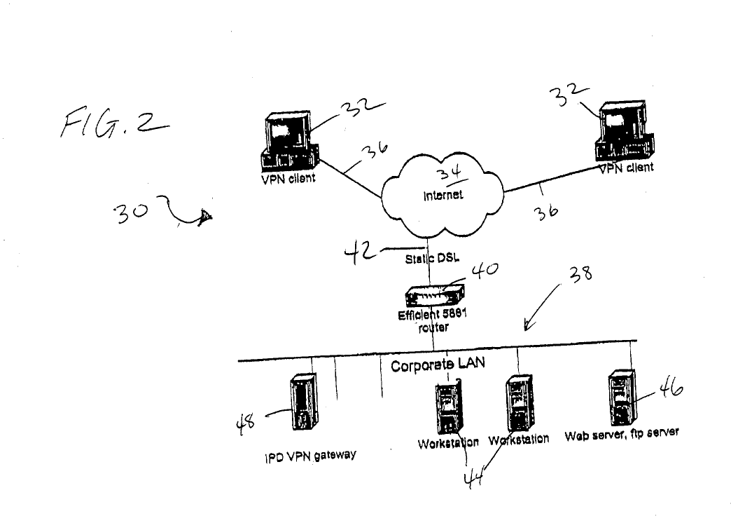

Referring to FIG. 2, a preferred embodiment of a virtual private network (VPN) 30 includes one or more VPN clients 32 in communication with the Internet 34 over telecommunication lines 36. The VPN clients may be individual computers or private networks. The telecommunication lines 36 may be land-lines, wireless communication networks, or any combination of the two. Although other communication line formats are contemplated, preferably the telecommunication lines 36 carry information in a digital subscriber line format. According to a preferred embodiment, the VPN network 30 also includes a private network 38 such as a corporate local area network (LAN) in communication with a digital subscriber line (DSL) router 40 that, in turn, is in communication over a static DSL line 42 with the Internet 34. The corporate LAN may include one or more workstations 44, web servers 46, and a VPN server 48. The VPN server 48 may be in communication with one or more computers in the LAN associated with private IP addresses.

In one preferred embodiment, the DSL router is any router capable of routing the appropriate data format and protocol, that is also programmable to handle IP address translations for LAN servers. One example of a suitable router is the Efficient Networks® 5861 router available from Efficient Networks, Inc. of Dallas, Tex. Any of a number of DSL routers may be used that have the capability to perform 1-to-1 mapping of public IP addresses to local network addresses. As used herein, the term “public IP address” refers to an IP address that is publicly registered and recognized on the Internet and the term “private IP address” refers to an IP address that is not publicly accessible or known on the Internet (e.g. an IP address internally assigned in a private network). Using any programming commands available with the type of DSL router selected, the mapping may be executed by a processor in the router using a static map of public IP address to private internal IP address such that queries from sources outside the LAN network over the VPN will only need or include the public IP address and the VPN server will only know of its private internal IP address.

The VPN protocol and encryption preferably uses IP layer encryption techniques. Encryption of the IP addresses using IP Security (IPSec), IP Protocol 50 or IP Protocol 51 are some of several suitable mechanisms for creating the VPN. Although the VPN encryption is preferably handled at the VPN server at the private network, the VPN encryption may be distributed over multiple devices at the private network (e.g. at both the VPN server and the DSL router). Any of a number of commercially available VPN solution software packages may be used to achieve the necessary VPN IP layer security. One example of a suitable VPN software package is the Secure VCN Software Suite available from IP Dynamics, Inc. of Campbell, Calif.

An example of how one type of system implementing the single IP address feature may be arranged is now set forth. A service provider of VPN solutions for individuals or organizations who have private networks may provide customers with VPN solution packages having, for example, a range of 5 IP addresses. These static IP addresses are assigned to the router by the service provider's network when the connection is made between the router and the service provider's network. If the customer does not plan to use all of the available addresses there is no need to make any configuration changes to the router. If the customer wants to host servers on their DSL network, the customer then configures the router using the steps below. Router configuration may vary, as is understood by those of ordinary skill in the art, if the router's configuration has been modified from the factory defaults.

Assuming that a DSL router such as an Efficient Networks® 5861 router is used, the service provider would give the customer a number such as 10.108.130.48/29 with a default gateway of 10.108.130.54. This means that the service provider has assigned a subnet address of 10.108.130.48 and a subnet mask of 255.255.255.248. The default gateway address of 10.108.130.54 is the address that is assigned to the DSL router. The customer can use the addresses from 10.108.130.49 to 10.108.130.53 for servers on his network. The specific addresses set out herein are merely by way of example. Any of a number of address arrangements may be used.

The DSL router preferably has a dynamic host configuration protocol (DHCP) server that automatically provides private IP addresses to the hosts when they are attached to the LAN or other private network. In other embodiments a separate DHCP server may be used. The DHCP server is configured to provide private addresses from, for example, 192.168.254.2 to 192.168.254.20. The addresses that are assigned to mapped host, such as one or more servers, in the private network should be outside this range to avoid conflicts. For this example it is assumed that the customer has decided to assign the addresses 192.168.254.101 to 192.168.254.105 to the mapped hosts. This arrangement of IP address assignments will not limit the number of computers on the customer's private network as all of the other computers on the LAN prefers use a network address port translation (NAPT) feature of a suitable router (e.g. the Efficient Networks® 5861 router and other routers containing NAPT features) to access the Internet for non-VPN communications.

To configure the DSL router, the service provider may access the router's command line prompt using a telnet session from a computer on the LAN or using the console port that may typically be found on routers. To then create the IP address map for one-to-one mapping of private, internal IP addresses to public, external IP addresses, the service provider would enter the appropriate commands, such “system addhostmap 192.168.254.101 192.168.254.105 10.108.130.49” and then “Save” for the DSL router from Efficient Technologies identified above.

These commands for the specific DSL router identified above, or any similar programming for other routers permitting the one-to-one mapping of addresses at the router, will map the external IP addresses one for one to the corresponding internal address. Any IP traffic arriving at the router at one of the external, public IP addresses will be forwarded to the host inside the private network having the internal IP addresses listed in the map programmed into the router. In this example, traffic directed to 10.108.130.51 (a public IP address) from a computer or network over the public Internet communication lines will be sent directly to the host 192.168.254.103 (a private IP address) in the private network by the router without passing through a separate firewall device, thus avoiding the need to expend a second public IP address on a firewall and avoiding the expense of any separate firewall equipment.

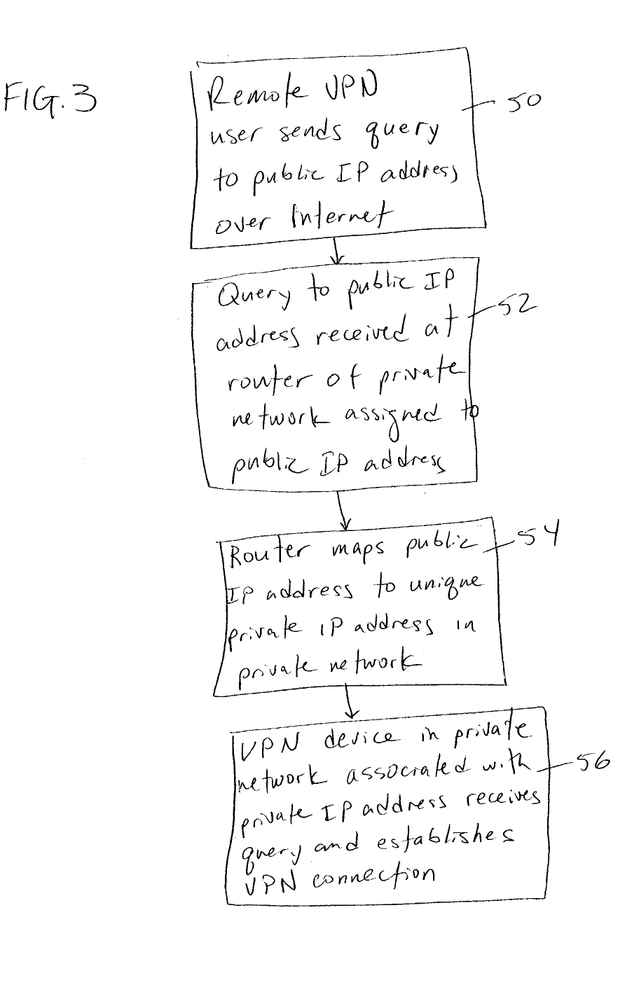

Referring to FIG. 3, when a remotely located VPN client wishes to access the private network over the VPN connection, the VPN client computer sends a query over the Internet to the DSL router at the public IP address assigned to the router, in this example 10.108.130.54 (at 50, 52). The DSL router automatically maps this public IP address to the one internal IP address associated with the VPN host in the private network (at 54). Once the VPN client reaches the VPN host, such as the VPN server 48 in FIG. 2, the user may then reach other destinations within the private network that are in communication with the VPN server of the private network by interacting with the VPN server to obtain authorization to, for example, send an email to an end user in the private network who is communication with the VPN server (at 56). The end user in the private network may be using a personal computer (PC) or some other network device. Alternatively, the VPN client computer user outside of the private network may wish to access a private intranet or file server in the private network. These, and any of the standard uses of a VPN to allow a remotely located computer user to securely access a destination in a private network, such as a LAN, are available through the method and apparatus of the presently preferred embodiments.

Users within the private network who wish to access destinations outside the private network have two options. They may decide to access the internet over a non-secure connection or over a VPN connection to a VPN client. For VPN communications, the private network user would launch VPN client software on his computer so that communications will be encrypted that are sent out through the router 40 and on to the VPN client on the other end. For non-VPN communications, the private network user would simply launch an application at his local computer (e.g. a web browser) and access various destinations on the Internet in the standard non-VPN manner. In either instance, the router 40 would treat both of these communications in the same manner. Each outgoing message would be mapped from the private IP address for the router to the appropriate public IP address and sent to the desired destination. In similar fashion, the same one-to-one mapping at the router would occur for communications coming into the router and private network regardless of whether it is VPN traffic or not.

Although the ability of creating a VPN with the use of only one public IP address per private network host has been described above with respect to a digital subscriber line (DSL) network, other networks are also contemplated. For example, ISDN networks or networks using dedicated Ti lines may be substituted for the DSL network. In these alternative embodiments, the DSL router will be replaced with an appropriate ISDN or TI router having the capability of one-to-one mapping between public IP addresses and private IP addresses. An advantage of the presently preferred method and system is that the use of a firewall may be eliminated along with the additional public IP address typically needed for identifying the firewall on the public network. Thus, a subscriber to any Internet service provider with a small local network may utilize a VPN according to the present invention with only a single static IP address and without the need for maintaining a separate firewall.

Although the present invention has been described with reference to preferred embodiments, those skilled in the art will recognize that changes may be made in form and detail without departing from the spirit and scope of the invention. As such, it is intended that the foregoing detailed description be regarded as illustrative rather than limiting and that it is the appended claims, including all equivalents thereof, which are intended to define the scope of the invention.

We claim:

1. A method of communicating between remotely located computers over a virtual private network connection established over an Internet connection, the method comprising:
receiving a query from a remotely located computer on a communication line over the Internet at a router, the query directed to a public Internet protocol address;
mapping the public Internet protocol address to a private Internet protocol address without using a firewall; and
establishing a virtual private network connection over the communication line and communicating between a host computer associated with the private Internet protocol address and the remotely located computer, wherein the host computer is accessible via a single public Internet protocol address.

2. The method of claim 1, wherein the communication line comprises a digital subscriber line.

3. The method of claim 2, wherein the router comprises a digital subscriber line router.

4. The method of claim 3, wherein mapping a public Internet protocol address comprises comparing, at the router, the public Internet protocol address to an address table in the router and obtaining the private Internet protocol address associated with the public Internet address from the address table, wherein the public Internet address is associated with a unique private Internet address.

5. The method of claim 3, wherein the public Internet protocol address comprises an address of a local area network.

6. The method of claim 1, wherein establishing a virtual private network connection comprises establishing an IP layer encryption between the remotely located computers.

7. A system for implementing a virtual private network over an Internet connection, the system comprising:
a router having at least one public Internet protocol address, the router comprising instructions for mapping the public Internet protocol address to a unique private Internet protocol address;
a virtual private network host associated with the private Internet protocol address and in communication with the router, the virtual private network connection with a remotely located computer in communication with the router over the Internet, wherein the virtual private network host is accessible by the remotely located computer via the public Internet protocol address and the public Internet protocol address is uniquely associated with the private Internet address without an intervening firewall.

8. The system of claim 7, wherein the Internet connection comprises a digital subscriber line connection and the router comprises a digital subscriber line router.

9. The system of claim 7, wherein the Internet connection comprises an ISDN connection and the router comprises an ISDN router.

10. The system of claim 7, wherein the Internet connection comprises a T1 connection and the router comprises at T1 router.

11. The system of claim 8, wherein the instructions for mapping the public Internet protocol address to the unique private Internet protocol address comprises a table of at least one public Internet protocol address and a unique Internet protocol address associated with each respective of the public Internet protocol addresses.

12. The system of claim 11 wherein the instructions for mapping comprise a table of at least one public Internet protocol address wherein each of the at least one public Internet protocol addresses is associated with a respective private Internet protocol address.

13. The system of claim 7, wherein the virtual private network host comprises instructions for forming a virtual private network connection.

14. The system of claim 12, wherein the instructions for forming a virtual private network comprise instructions for generating an IP layer encryption.

15. The system of claim 12, wherein the virtual private network host is part of a local area network.

16. The system of claim 15, wherein the VPN host is in communication with at least one computer within the local area network associated with a private Internet protocol address within the local area network.
